(19) United States
(12) Patent Application Publication
(10) Pub. No.: US 2010/0122477 A1
(43) Pub. Date: May 20, 2010

(54) Hydraulic actuator assembly and scraper using same

(75) Inventor: Robert Doyle Roley, Windsor, IL (US)

Correspondence Address: CATERPILLAR c/o LIELL, MCNEIL & HARPER;Intellectual Property Department, AH9510, 100 N.E. Adams, Peoria, IL, 61629-9510, US

(73) Assignee: Caterpillar Inc.

(21) Appl. No.: 12/291,959

(22) Filed: Nov. 14, 2008

(51) Int. Cl. E02F 9/22; F16H 25/12

(52) U.S. Cl. 37/416; 74/57

(57) ABSTRACT

An apron assembly includes an apron having an apron body extending between a first apron side and a second apron side. A portion of the apron includes an arcuate gear surface. A hydraulic actuator assembly includes a linear hydraulic actuator configured to actuate a drive gear, which is in mesh with the arcuate gear surface. According to an exemplary embodiment, the hydraulic actuator assembly is configured to translate linear motion into rotary motion.

### TECHNICAL FIELD

The present disclosure relates generally to a hydraulic actuator assembly, and more particularly to a hydraulic actuator assembly for translating linear motion into rotary motion. Such a hydraulic actuator assembly may be used to raise and lower an apron of a scraper, as described herein.

### BACKGROUND

Earthmoving equipment is used to perform a variety of operations, including loading, or capturing, material, such as soil, at one location and dumping, or depositing, the material at another location. For example, such material movement may be employed to adjust elevations at a project site. Scrapers, which typically provide quick load, dump, and maneuver time, may be used to perform such operations, and generally include a machine having a bowl within which material may be captured, and a cutting edge located adjacent a cut opening of the bowl. Although various scraper configurations are available, scrapers are often pulled by a tractor, such as a wheeled or track type tractor. In addition, scrapers may provide their own traction via a separate engine that applies rim pull, or power, to the wheels of the scraper. In either arrangement, scrapers may also be pushed or pulled by a separate machine, or tractor, to provide additional power for scraper operations.

During a typical operation, or duty cycle, an apron of the scraper may be pivoted upward, to a raised position, to open, or unblock, the cut opening of the bowl, and also to increase the capacity of the bowl. The scraper may be pulled forward, at a material capturing location, while the cutting edge of the bowl is pivoted downward to cut through the material. The cutting edge, oriented perpendicular to the direction of travel, may also serve to guide the material into the bowl. When the bowl is loaded to some desired capacity, the cutting edge of the bowl may be pivoted upward so that the cutting edge is out of contact with the material, and the machine may be transported to a location where the soil is to be deposited. In addition, the apron may be pivoted downward, to a lowered position, to prevent loss of the material during transport. After the material is deposited, often with the assistance of an ejector mechanism, the scraper may be returned to the material capturing location, and the duty cycle may be repeated.

To move the apron between raised and lowered positions, mechanisms for actuating mechanical linkages attached to the apron are often employed. According to one example, as shown in U.S. Pat. No. 3,016,633, an apron sector gear is fixed to the front center portion of the apron and follows the vertical section contour of the apron. The apron sector gear is driven by an electric motor through a suitable gear reduction. The electric motor and the gear reductions are fixed to the upper forward bowl structure and move the apron between open and closed positions. Although this arrangement may provide suitable actuation of the apron, it should be appreciated that there is a continuing need for actuation mechanisms that provide smooth operation, increased position resolution, and that satisfy strict spatial requirements.

The present disclosure is directed to one or more of the problems set forth above.

### SUMMARY OF THE DISCLOSURE

In one aspect, an apron assembly includes an apron having an apron body extending between a first apron side and a second apron side. A portion of the apron includes an arcuate gear surface. A hydraulic actuator assembly includes a linear hydraulic actuator configured to actuate a drive gear, which is in mesh with the arcuate gear surface.

In another aspect, a scraper includes a scraper bowl supported on a frame of the scraper. The scraper bowl includes a first bowl side and a second bowl side. An apron includes an apron body extending between a first apron side and a second apron side. The first apron side is pivotably attached to the first bowl side, and the second apron side is pivotably attached to the second bowl side. A portion of the apron includes an arcuate gear surface. A hydraulic actuator assembly includes a linear hydraulic actuator configured to actuate a drive gear, which is in mesh with the arcuate gear surface.

In yet another aspect, a hydraulic actuator assembly includes a linear hydraulic actuator having a cylinder end and a rod end. A drive block is coupled with the rod end and is mounted on a drive shaft. The drive block includes at least one inwardly extending projection positioned within a helical groove of the drive shaft. At least one drive gear is supported on the drive shaft.

### BRIEF DESCRIPTION OF THE DRAWINGS

FIG. 1 is a side diagrammatic view of a machine, according to the present disclosure;

FIG. 2 is a perspective view of one embodiment of an apron assembly of the machine of FIG. 1, the apron of the apron assembly being shown in a raised position, according to the present disclosure;

FIG. 3 is a perspective view of the apron assembly of FIG. 2, the apron being shown in a lowered position, according to the present disclosure;

FIG. 4 is a perspective view of another embodiment of an apron assembly of the machine of FIG. 1, the apron being shown in a lowered position, according to the present disclosure; and

FIG. 5 is a perspective view, shown in cross-section, of a portion of a hydraulic actuator assembly of the apron assembly of FIGS. 2 and 3 or FIG. 4, according to the present disclosure.

### DETAILED DESCRIPTION

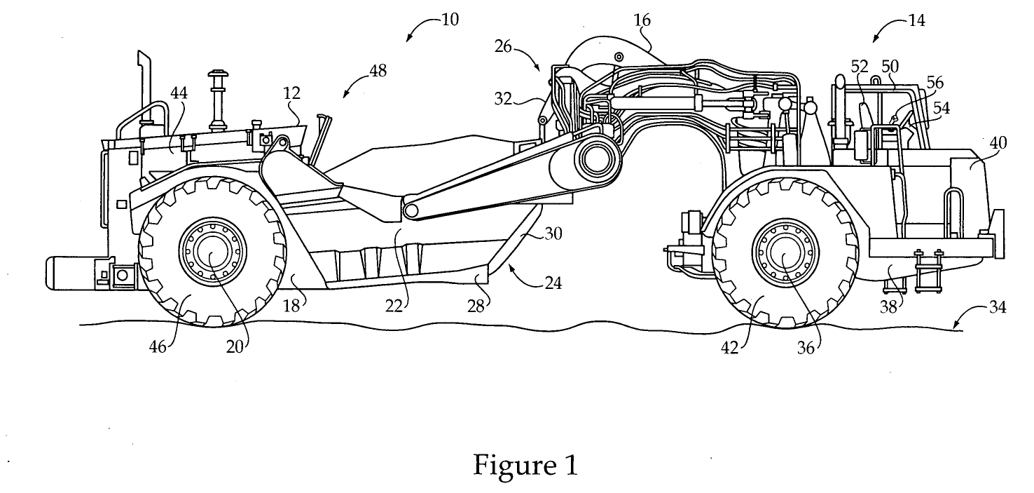

An exemplary embodiment of a machine 10 is shown generally in FIG. 1. The machine 10, as shown, includes a scraper 12 attached to a tractor 14 through an articulated hitch 16. Although the tractor 14 is depicted as a wheeled tractor, it should be appreciated that scraper 12 may be attached and, thus, pulled or towed by any machine or vehicle, including wheeled or track type tractors. The scraper 12, which may generally include a frame 18 having an axle assembly 20 about which a scraper bowl 22 may pivot, may also be operated in a variety of configurations, including, for example, a push-pull configuration, as is well known in the art.

Scraper bowl 22 may define a cut opening 24, at a front portion 26 of the scraper bowl 22, with a cutting edge, such as a scraper blade 28, positioned adjacent the cut opening 24. During an exemplary operation, an apron 30 may be pivoted upward, to a raised position, to open, or unblock, the cut opening 24, and also to increase the capacity of the scraper bowl 22. The scraper bowl 22 may be pivoted downward about the axle assembly 20, such as by using one or more scraper bowl actuators or cylinders 32, to engage the scraper blade 28 with material 34, such as, for example, soil. Such material 34 may be collected within the scraper bowl 22 as the tractor 14 and scraper 12 are maneuvered over the material 34. When the scraper bowl 22 is loaded to some desired capacity, the scraper blade 28 may be pivoted upward so that the cutting edge is out of contact with the material 34, and the machine 10 may be transported to a location where the material 34 is to be deposited. In addition, the apron 30 may be pivoted downward, to a lowered position, to close, or block, the cut opening 24 to prevent loss of the material 34 during transport. Although a simplified embodiment is described, it should be appreciated that scraper 12 may include additional components or features, such as, for example, an auger attachment, elevator mechanism, or ejector.

The tractor 14 may provide the sole means for propulsion and, in such arrangements, the tractor 14 and scraper 12 may include a single drive axle, such as, for example, a drive axle of a front axle assembly 36. The front axle assembly 36 may be coupled with a frame 38, or front frame, of the tractor 14, which may support a front engine compartment 40. An engine, such as an internal combustion engine, or other power source may be housed within the front engine compartment 40 and may provide power to front wheels 40 of the front axle assembly 36. According to some embodiments, the scraper 12 may also include propulsion means, such as an internal combustion engine or other power source disposed within a rear engine compartment 44, for driving rear wheels 46 of axle assembly 20, also referenced herein as a rear axle assembly. The rear axle assembly 20, disposed at a rear portion 48 of the scraper bowl 22, may thus, according to such tandem powered arrangements, provide its own power, or traction.

Either or both of the engines, such as internal combustion engines, of the front engine compartment 40 and the rear engine compartment 44 may provide power to a hydraulic system of the scraper 12. Specifically, an internal combustion engine of the machine 10 may power a hydraulic pump, which may provide a flow of hydraulic fluid to control one or more hydraulic devices of the machine 10. For example, such a hydraulic pump may supply a flow of high-pressure hydraulic fluid to one or more hydraulic actuators, such as scraper bowl cylinders 32, to the control movement of the scraper bowl 22. Hydraulic systems are known and only peripherally within the scope of the present disclosure. Therefore, such hydraulic control will not be discussed herein in greater detail.

An operator control station 50 may be supported on the front frame 38, and may include known devices, such as, for example, a seat assembly 52 and a steering device 54 that facilitate operator control of the tractor 14 and/or scraper 12. The operator control station 50 may include various other devices, including, but not limited to, one or more machine operation controllers 56. For example, one or more machine operation controllers 56 may be provided for selecting or controlling an engine speed of an internal combustion engine provided within either or both of engine compartments 40 and 44. Further, one or more machine operation controllers 56 may be provided for controlling operation of the scraper 12, such as by controlling movement of the scraper bowl actuators or cylinders 32. Additional controls and devices, as should be appreciated, may also be provided within the operator control station 50 for controlling various operational aspects of the tractor 14 and/or scraper 12. Such control, as referenced herein, may include either of mechanical or electronic control means, or a combination thereof.

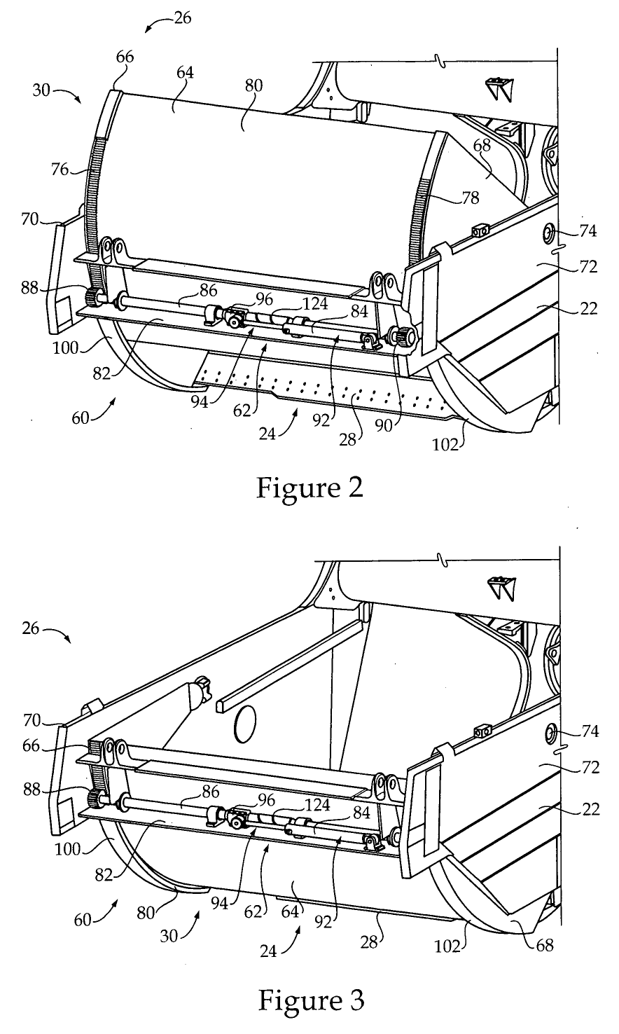

Turning now to FIG. 2, an exemplary apron assembly of scraper 12 is shown generally at 60. The apron assembly 60 may generally include the apron 30, of FIG. 1, and a hydraulic actuator assembly, shown generally at 62. The apron 30 may include an apron body 64, which may have a curved or arcuate shape, extending between a first apron side 66 and a second apron side 68. The first apron side 66 may be pivotably attached to a first bowl side 70 of the scraper bowl 22, while the second apron side 68 may be pivotably attached to a second bowl side 72 of the scraper bowl 22. For example, the second apron side 68 may be pivotably attached to the second bowl side 72 at a pivotable attachment point 74. It should be appreciated that any attachments allowing movement of the apron 30 between raised and lowered positions, relative to the scraper bowl 22, are contemplated for attaching apron 30 to the scraper 12.

As shown, a portion of the apron 30 may include a gear surface, such as an arcuate gear surface matching the contour of the apron body 64. Specifically, according to the exemplary embodiment, a first vertically aligned arcuate gear surface 76 and a second vertically aligned arcuate gear surface 78 may be positioned on an external side 80 of the apron 30. The first vertically aligned arcuate gear surface 76 may be positioned at, or near, the first apron side 66, while the second vertically aligned arcuate gear surface 78 may be positioned at, or near, the second apron side 68. Although specific embodiments are shown, it should be appreciated that one or more arcuate gear surfaces may be provided on any portion of the apron 30, such that a drive gear of the hydraulic actuator assembly 62 is positioned to engage the one or more arcuate gear surfaces of the apron 30. The hydraulic actuator assembly 62, according to the exemplary embodiment, may be supported on a support brace 82, which may be perpendicular to and extend between the first bowl side 70 and the second bowl side 72.

The hydraulic actuator assembly 62 may generally include a linear hydraulic actuator 84 configured to actuate one or more drive gears, which are in mesh with the first vertically aligned arcuate gear surface 76 and the second vertically aligned arcuate gear surface 78. For example, the linear hydraulic actuator 84 may be configured to rotate a drive shaft 86. The drive shaft 86, according to one embodiment, may support a first drive gear 88, which is rotatably coupled, or in mesh, with the first vertically aligned arcuate gear surface 76, and a second drive gear 90, which is rotatably coupled, or in mesh, with the second vertically aligned arcuate gear surface 78. Although rotary motion is described, it should be appreciated that the linear hydraulic actuator 84 may be configured to move a flat drive surface, such as a rack, in a linear direction to engage first and second vertically aligned arcuate gear surfaces 76 and 78. Such a drive surface, as should be appreciated, may also have a relatively vertical orientation.

The linear hydraulic actuator 84, which may be actuated using the hydraulic system described above, may be substantially parallel with the drive shaft 86, as shown, and may include a cylinder end 92 and a rod end 94. The rod end 94 may be rotatably coupled with a drive block 96 mounted on the drive shaft 86. The drive block 96, which, according to the exemplary embodiment, may be positioned along the drive shaft 86 between the first drive gear 88 and the second drive gear 90, may be configured to translate linear motion of the linear hydraulic actuator 84 into rotary motion of the drive shaft 86. As shown, the linear hydraulic actuator 84 and the drive shaft 86 may be substantially perpendicular to parallel planes defined by the first apron side 66 and the second apron side 68. Although specific orientations are described, it should be appreciated that the components of the hydraulic actuator assembly 62 may be positioned according to alternative arrangements and still provide the benefits described herein.

The hydraulic actuator assembly 62 may be configured to raise the apron 30 to a raised, or open, position, as shown in FIG. 2. Specifically, the linear hydraulic actuator 84 may be extended, using known hydraulic or other fluid means, such that the rod end 94 exerts a linear force on the drive block 96. The drive block 96 translates the linear force or motion into rotary motion, which is described below, causing rotation of the drive shaft 86. As the drive shaft 86 rotates, the first drive gear 88 and second drive gear 90, supported on the drive shaft 86, also rotate. Such rotation, in a first direction, causes the first drive gear 88 to engage the first vertically aligned arcuate gear surface 76, and the second drive gear 90 to engage the second vertically aligned arcuate gear surface 78, thus driving the apron 30 upward. When the linear hydraulic actuator 84 is retracted, using known hydraulic or other fluid means, the drive block 96 causes rotation of the drive shaft 86 in a second, or opposite, direction. Such opposite rotation causes the drive gears 88 and 90 to engage vertically aligned arcuate gear surfaces 76 and 78, respectively, to drive the apron downward, to a closed position shown in FIG. 3.

As shown in both FIG. 2 and FIG. 3, the scraper bowl 22 may include shields to protect the teeth of the gear surfaces, in at least one position of the apron 30. Specifically, the scraper bowl 22 may include a first arcuate shield 100 that extends from the first bowl side 70 and is aligned with the first vertically aligned arcuate gear surface 76 in the closed position of the apron 30. The second bowl side 72 may include a second arcuate shield 102 that extends from the second bowl side 72 and is aligned with the second vertically aligned arcuate gear surface 78 in the closed apron position. The first arcuate shield 100 and the second arcuate shield 102, and/or additional shields, may be integral with any portion of the scraper bowl 22 or, alternatively, the apron assembly 60, or may comprise separate components that are fixedly attached to the scraper bowl 22 or apron 30 using any known attachment means. In addition, the first and second arcuate shields 100 and 102 may match the contour of the apron body 64, and thus first and second vertically aligned arcuate gear surfaces 76 and 78, as shown.

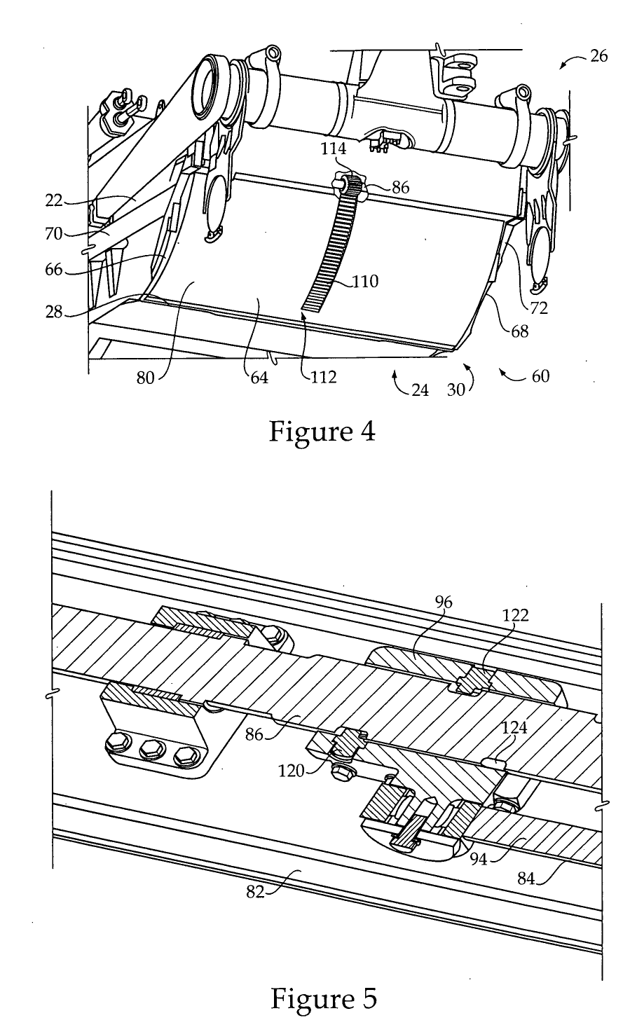

Although two drive gears 88 and 90 and two gear surfaces 76 and 78 are shown, it should be appreciated that any number and/or type of drive gear surface, driven by the linear hydraulic actuator 84, may be configured to drive any number and/or type of gear surfaces of the apron 30. For example, as shown in FIG. 4, the apron 30 may include a single vertically aligned arcuate gear surface 110 positioned on the external side 80 of the apron 30. Specifically, for example, the single vertically aligned arcuate gear surface 110 may be positioned at a central portion 112 of the external side 80 of the apron body 64. According to this exemplary embodiment, the drive shaft 86 may include a single drive gear 114 rotatably coupled, or in mesh, with the single vertically aligned arcuate gear surface 110. According to this, and other embodiments, the gear surfaces, and corresponding drive gears, may be positioned such that the linear hydraulic actuator 84 has sufficient space to fully extend and retract, as necessary.

Turning now to FIG. 5, the portions of the hydraulic actuator assembly 62 are shown in greater detail. Specifically, the drive block 96 may include at least one projection, such as a first inwardly extending projection 120 and a second inwardly extending projection 122, positioned within a helical groove 124 of the drive shaft 86. When the linear hydraulic actuator 84 is extended, the rod end 94 exerts a linear force on the drive block 96. As the drive block 96 moves, in a linear direction, the first and second inwardly extending projections 120 and 122 engage the helical groove 124, thus causing rotation of the drive shaft 86 in a first direction. As the rod end 94 of the linear hydraulic actuator 84 is retracted, the drive block 96 is moved in an opposite direction, causing first and second inwardly extending projections 120 and 122 to engage the helical groove 124 and rotate drive shaft 86 in a second, or opposite, direction.

It should be appreciated that the apron 30 and hydraulic actuator assembly 62, as described herein, may provide a means for adjusting a position of the apron 30 relative to the scraper bowl 22. Such adjustments may be made electronically and, further, may be made in response to a position of the front portion 26 of the scraper bowl 22 and/or a weight of material 34 within the scraper bowl 22. For example, it may be desirable to raise the apron 30 when the front portion 26 and, thus, scraper blade 28 is pivoted downward to engage the material 34. It may also be desirable to lower the apron 30 when the front portion 26 of the scraper bowl 22 is pivoted upward, such as when the scraper bowl 22 has reached a desired capacity. Alternatively, or additionally, such adjustments may be made manually, such as by actuating one or more of the machine operation controllers 56. Additional adjustments, as should be appreciated, may be made, as desired, throughout operation of the scraper 12.

### INDUSTRIAL APPLICABILITY

The present disclosure finds potential application in any machine, such as a tractor scraper or a towed scraper, which utilizes a bowl, such as a scraper bowl. Further, the disclosure may be specifically applicable to scrapers having a cutting edge located adjacent a cut opening of the bowl, and an apron that may be raised or lowered to effectively open or close the cut opening. Yet further, the present disclosure may be applicable to aprons, or apron assemblies, that require smooth operation and increased position resolution. Such machines may include, but are not limited to, single engine scrapers, tandem powered scrapers, scrapers operating in a push-pull configuration, and other machines known in the art that utilize a bowl and apron for collecting material.

Referring generally to FIGS. 1-5, a machine 10, such as a scraper 12, may be pulled by a tractor 14 and may generally include a frame 18 and a rear axle assembly 20, about which a scraper bowl 22 may pivot. The scraper bowl 22 may define a cut opening 24, at a front portion 26 of the scraper bowl 22, with a cutting edge, such as a scraper blade 28, positioned adjacent the cut opening 24. During a typical operation, or duty cycle, an apron 30 of the scraper 12 may be pivoted upward, to a raised position, to open, or unblock, the cut opening 24 of the bowl 22, and also to increase the capacity of the bowl 22. The scraper 12 may be pulled forward, at a material capturing location, while the cutting edge 28 of the bowl 22 is pivoted downward to cut through the material 34. When the bowl 22 is loaded to some desired capacity, the cutting edge 28 of the bowl 22 may be pivoted upward so that the cutting edge 28 is out of contact with the material 34, and the machine 10 may be transported to a location where the soil 34 is to be deposited. In addition, the apron 30 may be pivoted downward, to a lowered position, to close, or block, the cut opening 24 to prevent loss of the material 34 during transport. After the material 34 is deposited, the scraper 12 may be returned to the material capturing location, and the duty cycle may be repeated.

Utilizing the apron 30 and hydraulic actuator assembly 62, as described herein, may provide an improved means for adjusting a position of the apron 30 relative to the scraper bowl 22. Specifically, a linear hydraulic actuator 84 may be extended, using automatic or manual actuation means, such that a rod end 94 of the linear hydraulic actuator 84 exerts a linear force on a drive block 96. The drive block 96 translates the linear motion into rotary motion, by engaging inwardly extending projections 120 and 122 with a helical groove 124 of a drive shaft 86, causing rotation of the drive shaft 86. As the drive shaft 86 rotates, a first drive gear 88 and a second drive gear 90, supported on the drive shaft 86, also rotate. Such rotation, in a first direction, causes the first drive gear 88 to engage a first vertically aligned arcuate gear surface 76 of the apron 30, and the second drive gear 90 to engage a second vertically aligned arcuate gear surface 78 of the apron 30, thus driving the apron 30 upward.

Similarly, when the linear hydraulic actuator 84 is retracted, using automatic or manual actuation means, the drive block 96 causes rotation of the drive shaft 86 in a second, or opposite, direction. Such opposite rotation causes the drive gears 88 and 90 to engage vertically aligned arcuate gear surfaces 76 and 78, respectively, to drive the apron downward, to a closed position. Such an actuation means, as described herein, may provide improved actuation of apron 30. Specifically, the hydraulic actuator assembly 62 may provide smooth operation and increased position resolution of the apron 30, relative to the scraper bowl 22. In addition, the components of the hydraulic actuator assembly 62 may provide an actuation means that satisfies strict spatial constraints. Such a hydraulic actuator assembly 62 may have a variety of uses, in addition to apron actuation, especially in machines that are already equipped with hydraulic systems and have strict spatial requirements for actuation mechanisms.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. An apron assembly, comprising:
an apron having an apron body extending between a first apron side and a second apron side, wherein a portion of the apron includes an arcuate gear surface; and
a hydraulic actuator assembly including a linear hydraulic actuator configured to actuate a drive gear, the drive gear being in mesh with the arcuate gear surface.

2. The apron assembly of claim 1, wherein the linear hydraulic actuator is configured to rotate a drive shaft, the drive shaft supporting the drive gear.

3. The apron assembly of claim 2, wherein the linear hydraulic actuator includes a cylinder end and a rod end, the rod end being coupled with a drive block mounted on the drive shaft, wherein the drive block is configured to translate linear motion of the linear hydraulic actuator into rotary motion of the drive shaft.

4. The apron assembly of claim 3, wherein the drive block includes at least one inwardly extending projection positioned within a helical groove of the drive shaft.

5. The apron assembly of claim 2, wherein the linear hydraulic actuator and the drive shaft are substantially perpendicular to parallel planes defined by the first apron side and the second apron side.

6. The apron assembly of claim 5, wherein the drive shaft includes a first drive gear rotatably coupled with a first vertically aligned arcuate gear surface of an external side of the apron, and a second drive gear rotatably coupled with a second vertically aligned arcuate gear surface of the external side of the apron.

7. The apron assembly of claim 6, wherein the first vertically aligned arcuate gear surface is positioned at the first apron side, and the second vertically aligned arcuate gear surface is positioned at the second apron side.

8. The apron assembly of claim 5, wherein the drive shaft includes a single drive gear rotatably coupled with a single vertically aligned arcuate gear surface of an external side of the apron, wherein the single vertically aligned arcuate gear surface is positioned at a central portion of the external side.

9. A scraper, comprising:
a scraper bowl supported on a frame of the scraper and including a first bowl side and a second bowl side;
an apron having an apron body extending between a first apron side and a second apron side, the first apron side being pivotably attached to the first bowl side and the second apron side being pivotably attached to the second bowl side, wherein a portion of the apron includes an arcuate gear surface; and
a hydraulic actuator assembly including a linear hydraulic actuator configured to actuate a drive gear, the drive gear being in mesh with the arcuate gear surface.

10. The scraper of claim 9, wherein the linear hydraulic actuator is configured to rotate a drive shaft, the drive shaft supporting the drive gear.

11. The scraper of claim 10, wherein the linear hydraulic actuator includes a cylinder end and a rod end, the rod end being coupled with a drive block mounted on the drive shaft, wherein the drive block is configured to translate linear motion of the linear hydraulic actuator into rotary motion of the drive shaft.

12. The scraper of claim 11, wherein the drive block includes at least one inwardly extending projection positioned within a helical groove of the drive shaft.

13. The scraper of claim 10, wherein the linear hydraulic actuator and the drive shaft are substantially perpendicular to parallel planes defined by the first apron side and the second apron side.

14. The scraper of claim 13, wherein the drive shaft includes a first drive gear rotatably coupled with a first vertically aligned arcuate gear surface of an external side of the apron, and a second drive gear rotatably coupled with a second vertically aligned arcuate gear surface of the external side of the apron.

15. The scraper of claim 14, wherein the first vertically aligned arcuate gear surface is positioned at the first apron side, and the second vertically aligned arcuate gear surface is positioned at the second apron side.

16. The scraper of claim 15, wherein the first bowl side of the scraper bowl includes a first arcuate shield extending therefrom and being aligned with the first vertically aligned arcuate gear surface in at least one position of the apron; and
wherein the second bowl side of the scraper bowl includes a second arcuate shield extending therefrom and being aligned with the second vertically aligned arcuate gear surface in the at least one position of the apron.

17. The scraper of claim 13, further including a support brace being perpendicular to and extending between the first bowl side and the second bowl side, wherein the drive shaft and the linear hydraulic actuator are supported on the support brace.

18. A hydraulic actuator assembly, comprising:
a linear hydraulic actuator having a cylinder end and a rod end;
a drive block coupled with the rod end and mounted on a drive shaft, the drive block including at least one inwardly extending projection positioned within a helical groove of the drive shaft; and
at least one drive gear supported on the drive shaft.

19. The hydraulic actuator assembly of claim 18, wherein the linear hydraulic actuator and the drive shaft are substantially parallel.

20. The hydraulic actuator assembly of claim 19, wherein the drive block is positioned along the drive shaft between a first drive gear and a second drive gear.
